(19) United States
(12) Patent Application Publication
(10) Pub. No.: US 2014/0225867 A1
(43) Pub. Date: Aug. 14, 2014

(54) WALL COVERING ELEMENT WITH DETECTION SYSTEM

(71) Applicant: GROSSENBACHER SYSTEM AG, St. Gallen (CH)

(72) Inventor: Andreas Schimanski, Sigolsheim (FR)

(73) Assignee: GROSSENBACHER SYSTEM AG, St. Gallen (CH)

(21) Appl. No.: 14/351,281

(22) PCT Filed: Sep. 20, 2012
(86) PCT No.: PCT/EP2012/003930

§ 371 Date: Apr. 11, 2014

(30) Foreign Application Priority Data
Oct. 14, 2011 (DE) 10 2011 116 000.4

(51) Int. Cl. G06F 3/044; G06F 3/041; G06F 3/042

(52) U.S. Cl. CPC G06F 3/044; G06F 3/0425; G06F 3/0416
USPC 345/174

(57) ABSTRACT

At least partially transparent sheet-like covering element (2) provided with a detection system for the presence and/or characterization of an object or a material and associated further embodiments of the invention. The covering element is characterized in that it is fitted in front of or to the wall substrate of a wall of a building, substantially over the entire surface thereof, and the detection system (operating element, “touch panel”) operates according to the “projected capacitive touchscreen” principle and is provided or implemented such that it rests against the transparent sheet-like covering element on the rear side (wall side), as seen by the observer, and is provided or implemented in front of or in the wall substrate having the covering element. Uses are, for example, the control of devices and functions in operating theatres or other rooms.

### BACKGROUND

The invention relates to an at least partly transparent, planar covering element, equipped with a detection system for the presence and/or characterization of an object or a substance, and further embodiments of the invention accompanying this, and uses.

Such covering elements are known from computer technology, for example in the form of touch-sensitive screens (“touchscreens”) which, inter alia, in portable telecommunication appliances such as PDAs or cellular telephones, navigation appliances, computers (such as desktops, laptops, hand-held or so-called “tablet” computers, see e.g. WO 2005/114369); automated teller machines; ticket machines; interactive petrol pumps or else applications attached behind display windows or under glass store tables and also games integrated into counters, for example in the form of display windows (see e.g. WO 96/15464).

On the other hand, it is common practice to provide the inner walls of operating theaters with glass walls in order to obtain surfaces which have as few joints as possible (which, within the scope of the present disclosure, means “few joints” in particular) and which can be kept in a good, unobjectionable hygienic state (which is also referred to as “blue operating theater” since it is inherently blue or has corresponding illumination by e.g. LEDs). An attempt is generally made here to make operating functions of the operating theater, including e.g. control functions for the medical appliances and devices (e.g. operating site cameras, C-arms, ultrasound appliances, operating microscopes (OPMs), endoscopic switching elements (for example for endoscopic light), recording appliances for logging an operation and the like) and peripheral systems (e.g. room cameras, light and audio control, operating theater lamp, operating theater table lamp, room light control, insufflators, video conferencing systems and the like) operable from a central touchscreen, which is embodied on the screen surface of a device with a screen, which device is set up freely in the operating theater or suspended from a wall or ceiling (cf. e.g. http://www.olympus-oste.eu/front_content.php?idcat=27&idart=121).

It is disadvantageous here that, firstly, the many functions accessible via a touchscreen can lead to confusion and errors in the operation during surgery and, secondly, that it is difficult to keep the free-standing touchscreen operating unit clean, and moreover it can restrict the clear space for the surgeons due to its necessity to be accessible at all times. Therefore, it would be advantageous to make functions which are not required to be directly accessible from the operating site, in particular basic functions of the room such as illumination regulation, ventilation regulation, temperature regulation or the like, to be actuatable from separate operating devices.

Touchscreens as operating elements for automating functions are also known in the domestic and office sector (“home automation”, for example for controlling the heating, TV appliances, the oven, music equipment, home cinema equipment or the like) and are primarily placed onto the walls or installed into the wall so that they can be touched directly from the outside. A disadvantage here is that the touchscreens can protrude or have joints with the surrounding wall material and may be “visible”, i.e. this may adversely affect the aesthetics.

### SUMMARY

It is therefore an object to integrate operating elements in such a way that the aforementioned disadvantages could be avoided.

This object is achieved by a covering element, as set forth at the outset, which is characterized in that the covering element is attached in front of, or on, the wall substrate of a wall of a building, substantially over the whole area thereof, and the (at least one) detection system (operating element, “touch panel”) operates according to the “projected capacitive touchscreen” principle and is provided, or configured, adjacent to the transparent, planar covering element, situated on the rear side (wall side) as seen from the observer, and in front of, or in, the wall substrate with the covering element (in contact with the covering element or with a small spacing, i.e. not completely encapsulated by the wall substrate). The detection system or the detection systems is/are preferably arranged only behind part of the area of the covering element.

In a further embodiment, the invention also relates to the use of at least one detection system operating according to the “projected capacitive touchscreen” principle (also referred to as projected capacitive touch principle), characterized in that this, in the form of an operating element (“touch panel”), is placed in front of and/or in a wall substrate and behind a transparent covering element (in contact with the covering element or with a small spacing, i.e. not completely encapsulated by the wall substrate), wherein the detection system or the detection systems is/are preferably arranged only behind part of the area of the covering element.

The invention also relates to the use of a covering element, equipped according to the invention with at least one detection system, for carrying out (in particular during surgery or just before or thereafter) control functions for medical appliances and devices (e.g. operating site cameras, C-arms, ultrasound appliances, operating microscopes (OPMs), endoscopic switching elements (for example for endoscopic light), recording appliances for logging an operation and the like) and, in particular, peripheral systems (e.g. room cameras, light and audio control, operating theater lamp, operating theater table lamp, room light control, insufflators, video conferencing systems and the like), in particular functions which need not be directly accessible from the operating site, in particular basic functions of the room such as illumination regulation (e.g. also for LEDs of the OLEDs), ventilation regulation, temperature regulation or the like, or else for the domestic and office sector, for controlling the heating, TV appliances, the oven, music equipment, home cinema equipment or the like, wherein the detection system is employed as operating element.

The following definitions describe embodiments of the invention, which can be exemplary or preferred, wherein one or more general terms, which are used for determining subject matter of the invention, can in each case be replaced by the narrower definition(s) or term(s), which in each case leads to special embodiments of the invention.

The detection system to be employed according to the invention is, in particular, an operating element which can simultaneously work as input and output appliance, in which the program flow of an appliance or of a device (e.g. medical appliances or basic functions in operating theaters, as set forth at the outset) can be controlled directly or via control elements by touching (in particular of the covering element) in the region of parts of an image. As standard, it generally comprises as components a touch sensor, which produces signals in the case of proximity of, or contact with, objects, such as, in particular, fingers (exposed or covered by e.g. glove material) or pointers, or further substances (material), a control unit, which translates the signals received from the sensor for a computer, and a software driver, which enables the interpretation, processing and use of the data supplied by the control unit, for example for actuating technical appliances or devices, like those set forth above in the introduction or else illumination elements. It is possible, in each case, for there to be one or more touch sensor, control unit, software driver and constituents mentioned below. Furthermore, as further components, the detection system according to the invention preferably also contains an imaging element (for example for displaying operating alternatives), usually in the form of an integrated screen, or alternatively (e.g. if it is only the same operating alternatives that are to be shown in each case) in the form of unchanging images, such as printouts, and the aforementioned computer.

Further constituents, such as actuated or actuatable appliances or devices (e.g. medical appliances and devices (e.g. operating site cameras, C-arms, ultrasound appliances, operating microscopes (OPMs), endoscopic switching elements (for example for endoscopic light), recording appliances for logging an operation and the like) and, in particular, peripheral systems (e.g. room cameras, light and audio control, operating theater lamp, operating theater table lamp, room light control, insufflators, video conferencing systems and the like), in particular functions which need not be directly accessible from the operating site, in particular basic functions of the room such as illumination regulation, ventilation regulation, temperature regulation or the like, or else for the domestic and office sector, for controlling the heating, TV appliances, the oven, music equipment, home cinema equipment or the like, wherein the detection system is employed as operating element), A/D converters, multiplexers and filters and the like, and also suitable algorithms for application and use of a detection system according to the invention are known to a person skilled in the art and are therefore not explicitly mentioned or described herein.

Suitable pointer devices which may influence electromagnetic fields, such as appropriate pointers or others (e.g. tools in the hands of a person, which saves these having to be put down first) or, in particular, one or more hands or, preferably, one or more fingers, come into question as object, which pointer devices are brought into the vicinity of the operating element, for example, and in particular, by touching the transparent, planar covering element.

The substances can be materials which come into contact with a covering element, such as e.g. condensing moisture or dirt, which can then set in motion measures for keeping the surface clean, such as heating for removing condensed water, automated washing or cleaning processes or more of the like.

At least partly transparent means that the covering element is at least partly transmissive to electromagnetic waves, in particular in the range visible to the human eye, such that images on the rear side, or therebehind, can be perceived. It may also be possible to interrupt the transparency, e.g. by electrically switchable (activatable and deactivatable) light transmissivity (“intelligent glass”) such that e.g. images lying thereonly behind become visible during contact. This allows different design effects to be achieved on the aforementioned technical basis. “Partly” in this case means that regions without detection system (operating element, “touch panel”) lying therebehind can also be (permanently) non-transmissive (non-transparent), while the regions behind which one or more detection systems lie must be at least temporarily transparent. However, the whole covering element can also be configured to be transparent.

A corresponding covering element can consist of a coated (for example coated by a surface-hardening, anti-glare, electrochromic, colored (e.g. by printing) or any other possible material or coating system or, for example, LEDs or OLED material or the like enabling the appearance of the covering element to be varied as desired) or an uncoated—transparent material, such as plastic or, in particular, glass (e.g. soda-lime glass or aluminum-silicate glass), also in the form of composite glass. Here, due to the use of the “projected capacitive touchscreen” principle, the thickness should lie in the range between 0.1 and 30 mm, preferably between 0.2 and 20 mm, e.g. from 0.2 to 10 or from 2 to 18 mm, for example at 2 to 8 mm.

The images are one or more of those displayed on a screen, which is a constituent of the detection system according to the invention, for example displayed visible elements of graphic user interfaces (GUIs), which display graphic elements, control elements or else referred to as “widgets”. A window structure may be provided, wherein the GUI system renders it possible to modify such windows in terms of their size and position, to minimize said windows or to maximize these to fill the entire screen. Displayed graphic user interfaces are available for, or even integrated into, many multipurpose operating systems. Buttons, toolbars, sliders, list boxes and icons are further displayed operating elements. Moreover, dialog boxes (also referred to as “dialog fields”) are usually used for user queries or entries, such as the selection of a printer.

By using clear symbols for specific program functions, such as the recycle bin, GUIs can substantially simplify learning and understanding of the operation.

By way of example, covering elements according to the invention can have areas between 2 and 500 square meters (m²), such as between 3 and 50 m², without this intending to be restrictive.

According to the invention such a covering element is attached in front of, or on, the wall substrate of a wall of a building, substantially over the whole area thereof, wherein said covering element, if need be, may be divided into a plurality of covering element modules, which are interconnected with as few joints as possible, preferably with only very smooth and narrow joints with a width of less than 2 mm, optionally closed by putty (preferably with surfaces flush), for example if the individual covering element modules can only be produced up to a maximum size. This means that it is can be in direct contact with the wall substrate (wall material) (the required parts of the detection system can then be e.g. embedded into the wall substrate), e.g. a wall material selected from: concrete, masonry, e.g. of shaped bricks, bricks, cemented bricks or shaped bricks, stone (e.g. granite or marble) plates, wood, a composite material, or furthermore plastic, or the like, in each case with or without insulation and/or rendering material, (e.g. by application or at least partial adhesive bonding) or may be a certain distance therefrom, for example at a distance of a few millimeters to many centimeters, e.g. from 1 to 50 mm or up to 500 mm (e.g. also to apply the parts of the detection system wholly or partly in the wall material and/or to enable rear ventilation), on the side facing away from the observer and to the wall substrate, as a result of which it is possible, for example, to smooth unevennesses of the wall material or provide an e.g. insulating interspace. To this end, it can be kept at a suitable distance by spacers and may be e.g. separable (e.g. using screws) or (at least substantially, i.e. under normal usage conditions, in particular without irreversible damage during separation) inseparable (e.g. adhesively bonded (cohesion), connected with force fit and/or in an interlocking manner, e.g. clipped on). Force fit connections assume a normal force on the areas to be connected to one another. Their relative displacement is prevented as long as the counteracting force caused by static friction is not exceeded. In the case of an interlocking connection, one connection partner is in the way of the other one (at least in part, in particular during the attempt to release or rotate the connection).

Those covering elements which (when attached to walls, floors and/or ceilings) in each case adjoin covering elements in front of, or on, the other adjacent walls, ceilings and/or floors without joints are more preferable.

Without joints always means that no, or only very small, joints (gaps) are admissible between adjacent elements (i.e., more specifically, actually few joints or without joints), for example joints with widths between 0 and 5 mm, preferably between 0 and 2 mm, wherein the joints can, if desired, be filled with suitable materials (e.g. cemented, for example artificial resin such as on epoxide or silicone basis) in order to ensure surfaces which are as smooth as possible and have little deposition options for contaminations or dirt.

The detection system or systems can be arranged over the whole area of a covering element according to the invention or, preferably, only behind part of the area of the covering element, e.g. at a suitable height (for example, at the bottom, e.g. in the lower third of the covering element, for foot operation, and the central or upper region, e.g. in the central third in relation to the height of the covering element, for hand operation, or with suitable lateral positioning. By way of example, the detection system or systems can be provided only behind 0.5 to 40%, or 1 to 10%, in each case of the area of the covering element.

The at least one detection system (operating element, “touch panel”) normally operates according to the “projected capacitive touchscreen” principle and is provided lying on the rear side (i.e. the side of the wall substrate) of the transparent, planar covering element as seen from the observer, and in front of, or in, the wall substrate with the covering element. By way of example, it can be embedded into recesses in the wall substrate, wherein the front side (with the capacitance sensitive part or parts) can be in direct (which can also mean via a liquid) contact with the covering element or it can be provided applied to the wall material or partly integrated therein.

Here, the “projected capacitive touchscreen” principle renders detection or else characterization (e.g. in respect of size or type, e.g. fingertip or hand area) of objects or substances, in particular of one or more objects, such as (e.g. gloved or uncovered) fingers, brought into the proximity of, or directly into contact with, the covering element for touching the surface of the transparent covering element, by means of the detection system possible, even without the latter itself being touched (which provides good protection for the latter against negative influences).

Here, although other principles are feasible, such as sound wave-controlled systems (“surface acoustic QWAV=SAW), optical systems (e.g. infrared grating), inductive touchscreens (only operable by means of a pointer equipped with an integrated coil) or dispersive signal technology systems, in which vibration waves are used to measure contact), the “projected capacitive touchscreen” principle is particularly suitable since it also enables simultaneous detection of movement directions and/or contact points of the plurality of the fingers or objects (“multi-touch”). By way of example, this enables “drag-and-drop” operations (e.g. rotating, scaling, displacing images).

Single or multi-point sensitive arrangements on the basis of the “self capacitance” principle or arrangements on the basis of the “mutual capacitance” principle are particularly suitable. Here, self capacitance represents self capacitance; mutual capacitance represents mutual capacitance between two conductors.

In general, a detection system according to the invention/a detection system used according to the invention has a plurality of sensor nodes or coordinates, which can operate independently of one another and which represent different points on an operating element (touchscreen). Thus, in one embodiment of the invention, a touchscreen as a constituent of the detection system can be based a multiplicity of (capacitance-sensitive) nodes sensitive to the capacitance, which nodes can have very variable configurations.

In the case of “self capacitance”, the inherent (“self”) capacitance of in each case an individual electrode is measured relative to ground. In the case of “mutual capacitance”, the capacitance is determined between a node of a first and a second electrode. In both cases, each one of the nodes operates independently of the other nodes when producing a signal representative for the location thereof (or, in the case of e.g. simultaneously occurring signals, representative for the different touched points of the touchscreen).

In order to embody the touchscreen to be transparent (as defined above) and thereby enable the viewing of images of a screen with e.g. a GUI display situated therebehind, the capacitance-sensitive nodes are preferably formed from a transparent conductive material, such as, in particular, indium tin oxide (ITO).

In the case of “self capacitance”-based arrangements, the transparent material is subdivided into spatially separated electrodes and conductor tracks. Each of the electrodes represents a specific coordinate and the conductor tracks connect the electrodes with a capacitance-sensitive circuit. The coordinates can be linked or reproduced using Cartesian (x and y) or polar (r, θ) coordinates, or other coordinate systems. In the case of the Cartesian coordinate system, the electrodes can be arranged in rows and columns such that they form a grid arrangement, wherein each electrode represents a different x, y-coordinate. During use, the capacitance-sensitive circuit records changes in the capacitance of each one of the electrodes. The points at which changes occur (e.g. by contact by a finger or by dragging a finger over the surface of the covering element) and the magnitude of the changes are used to detect single or multiple touch events. A change in the capacitance usually occurs at an electrode if a user places an object or substance, for example a finger, in close vicinity of the electrode, i.e. the object or the substance withdraws charge and, in the process, influences the capacitance.

In the case of “mutual capacitance”, the conductive material is arranged in groups in a pattern of spatially separated conductor tracks, which are arranged in two different layers. “Driving” (active) conductor tracks are arranged in a first layer and “sensor” (passive) conductor tracks are arranged in a second layer. Although separated by the arrangement in different layers, the sensor conductor tracks pass over, cut or cross the driving conductor tracks and thus form nodes with capacitive coupling. The manner in which the sensor conductor tracks pass over the driving conductor tracks depends on the utilized coordinate system. By way of example, in the case of the Cartesian coordinate system, the sensor conductor tracks are arranged substantially perpendicular to the driving conductor tracks and thus form nodes with uniquely assigned x- and y-coordinates. Alternatively, the sensor conductor tracks can form concentric circles in the polar coordinate system, while the driving conductor tracks can be arranged as radially extended tracks, or vice versa. The driving conductor tracks are connected to a voltage source and the sensor conductor tracks are connected to capacitance-sensitive circuits. During operation, a current is conducted through in each case only one driving conductor track at any given time, and, as a result of the capacitive coupling, the current is conducted by the sensor conductor tracks through each of the nodes (points of intersection) between the sensor conductor track and the driving conductor track. The capacitance-sensitive circuit registers changes in the capacitance of each individual node. The points at which changes occur, and the intensity thereof, can be used to detect single or multiple touch events. A change in the capacitance usually occurs at a capacitive coupling node as soon as a user places an object or substance, for example a finger, in close vicinity of the node, i.e. the object or substance withdraws charge and, in the process, influences the capacitance.

Corresponding arrangements of conductor tracks for “self capacitance” and “mutual capacitance” are known, for example as shown in WO 2005/114369 or in G. Barret and Ryomei Omote, “Projected-Capacitive Touch Technology”, Information Display 3/10, 2010, which, in this respect, are incorporated here by reference. They also describe further arrangements known per se to a person skilled in the art, the production of corresponding arrangements and elements (such as controllers) connected thereto.

An appearance largely unaffected optically by the electrodes or conductor tracks can be achieved, in particular, by virtue of a material with similar optical properties as the transparent, conductive material of the nodes, conductor tracks or electrodes being applied in the interspaces between the conductor tracks and electrodes, in particular ITO itself (in this case insulated electrically, for example by small gaps).

One or more detection systems can be provided for each covering element, which detection systems can assume operating problems in cooperation or separately from one another and thereby enable the actuation of very different functions.

Applied substantially over the whole area thereof means that, at best, relatively small edge regions (for example less than 10, preferably less than 5, in particular less than 2%) of the area of the wall substrate are still free from the transparent covering element attached thereto, or in front thereof. The whole area of the wall is preferably covered by the transparent covering element or the transparent covering element is embodied in such a way that it is connected to adjoining covering elements (in particular in respect of their planar planes, which are perpendicular to one another or to the plane of the first covering element) on wall regions, or else on ceiling, wall and ceiling regions and/or floor regions, of a room in a flush manner, enabling equipment of the room without joints and thus is useful, particularly in the scope of sterile rooms, such as operating theaters.

The fact that a detection system of a transparent, planar covering element according to the invention situated on the rear side is provided adjacent to and in front of, or in, the wall substrate with the covering element (in contact with the covering element or with a small spacing, i.e. not completely encapsulated by the wall substrate) means that it has to be arranged in such a way that a change in capacitance by an object or a substance is still detected by the detection system, i.e. it can still be coupled therein. This, as well as a sufficiently precise localization of the proximity or contact points of the object or material, can be made more difficult or even impossible by a distance that is too large or by material of the wall substrate lying therebetween. By way of example, without this intending to restrict the general invention, distances between the respective detection element and the respective covering element of up to 20, in particular of up to 8 mm are thus possible.

In particular, the invention also relates to a room in a building, for example a room in a domicile or, in particular, an operating theater, which has at least one wall on which one or more of the transparent, planar covering elements according to the invention is applied, which is equipped with one or more of the aforementioned detection systems, wherein the remaining walls can likewise (preferably in the case of an operating theater) be covered by such covering elements (with or without detection system), e.g. made of glass or composite glass, as well as the ceilings and optionally also the floor. Here, “applied” means applied in front of, or on, the wall substrate of a wall, a floor or ceiling of a building, substantially over the whole area thereof. This means that the covering element or elements are in direct contact with the wall substrate (wall material), for example a wall material selected from concrete, masonry, e.g. of shaped bricks, bricks, cemented bricks or shaped bricks, stone (e.g. granite or marble) plates, wood, a composite material, or furthermore plastic, or the like, in each case with or without insulation and/or rendering material, (e.g. by application or at least partial adhesive bonding) or may be a certain distance therefrom, for example as described above.

By way of example, a building is understood to mean a house with one or more domiciles or, in particular, a hospital building, but also any other functional building such as a garage, an underground garage, a hall (e.g. concert hall, theater hall or multi-purpose hall) building, an airport building, a train station building.

Signals can be transmitted between components of a covering element according to the invention with detection system by means of lines (for current or for light, as in the case of glass fibers) or (particularly easily) by means of radio or electromagnetic waves in the visible or IR range, or in any other suitable manner.

### BRIEF DESCRIPTION OF THE DRAWINGS

In the following text, specific embodiments according to the invention will be described on the basis of figures.

FIG. 1 schematically shows, in a cross section and as a section in an exploded drawing, the setup of an exemplary, at least partly transparent, planar covering element according to the invention, in which the associated detection system is adhesively bonded directly without gap to a covering element (e.g. glass wall) from behind.

FIG. 2 schematically shows, in a cross section and as a section in an exploded drawing, the setup of an exemplary, at least partly transparent, planar covering element according to the invention, in which the associated detection system is attached to the respective counter pieces thereof by means of bolts and nuts attached (e.g. adhesively bonded) on the covering element (e.g. glass wall), wherein there is a gap between covering element and operating element (“touch panel”) situated therebehind, which may be filled with a contact liquid. Said contact liquid preferably has a refractive index approximately equal to that of the covering element and/or the facing surface of the detection system.

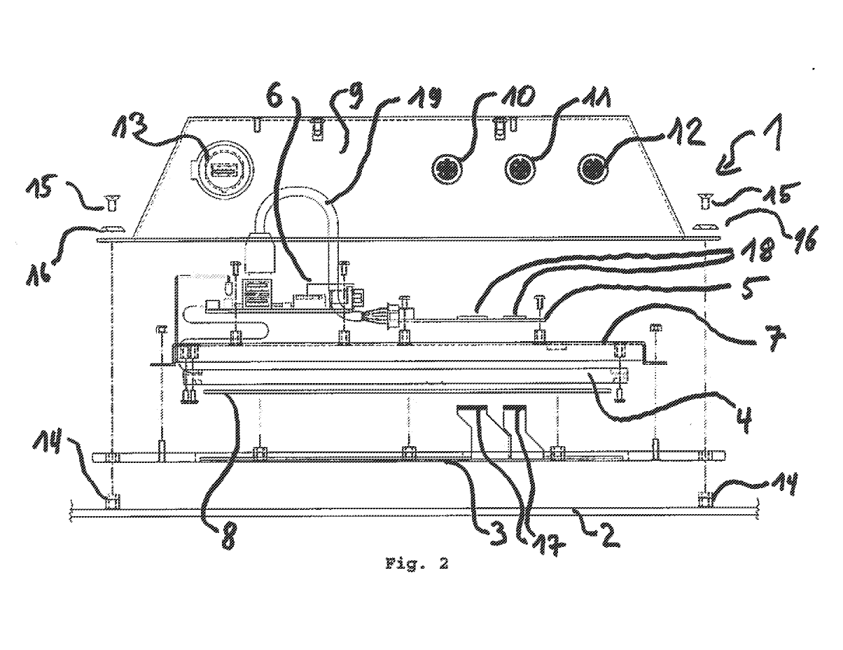

### DETAILED DESCRIPTION OF THE PREFERRED EMBODIMENTS

The following examples illustrate the invention without restricting it; however, they also constitute preferred embodiments of the invention; this also applies to the descriptions of the drawing.

### EXAMPLE 1

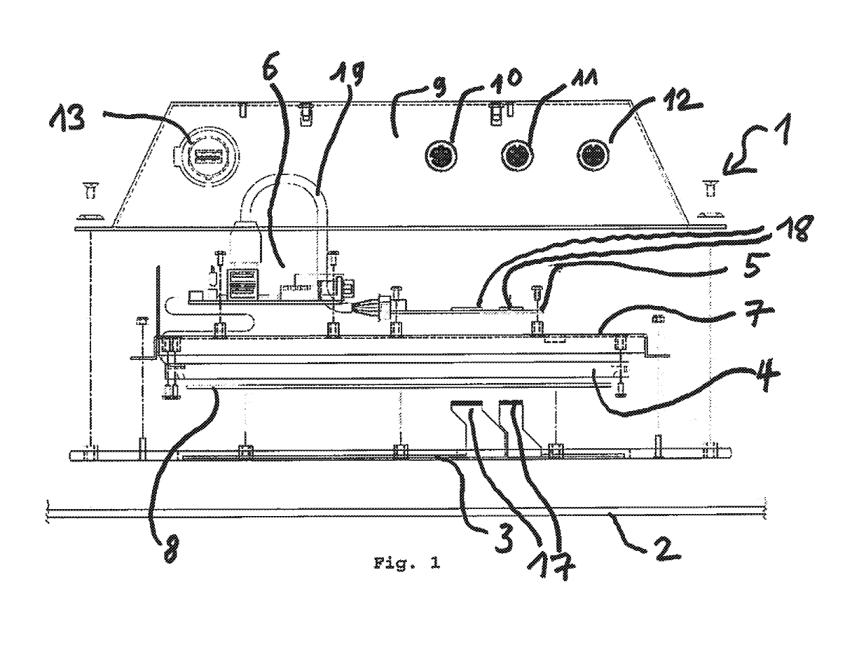

FIG. 1 schematically shows the setup of a transparent, planar covering element according to the invention, in this case in the form of an acrylic glass pane or, in particular, (an optionally composite) glass pane, of which a section with an associated detection system (1) is shown, wherein the covering element (2) may be tinted in color, e.g. printed black, or illuminated by means of LEDs (e.g. white and/or blue) (not shown) e.g. outside of the region of the detection system (1) according to the invention (for example from behind, i.e. wall-side, i.e. above the covering element in the figure) for design reasons or for improving the functionality. The associated detection system (1) is provided directly adhesively bonded without gap to the covering element (2) (e.g. glass wall) from behind (in this case, it is shown in the state to be adhesively bonded), which may make separate provisions for preventing optical interference, such as Newton rings, unnecessary. The detection system (1), used according to the invention, in this case embodied as touch panel, contains a touch sensor (3), furthermore an imaging element (4) (embodied here as screen), a control unit (5) and a computer (6) with software drivers. As shown in FIG. 1, the computer (6) and the control unit (5) can be brought into direct contact (as shown here via screws, but also via different fastening options), via a screen mount (7), for example a display sheet, with the imaging element (4) and can be connected thereto and to the covering element (2) by means of suitable fastening methods (such as the adhesively bonded bolts and associated nuts shown here), wherein a dust seal (8) can also be provided. A cover (9) (shown in folded-up top view) be provided with different connectors, such as one or more selected from an Ethernet connector (10), an RS-422/RS-232/CAN connector (11), a 24 volt connector (12) and a USB connector (13), or a LON or BACnet, for example to enable the actuation of external appliances or devices (not shown here) by means of suitable connections, wherein it is also (in a complementary manner) or alternatively possible for radio links to be provided. Here, the detection system (1) together with the remaining aforementioned components is provided in a recess in a wall (not shown here) and can for example be provided to be accessible from the rear side thereof or via channels in the interior thereof. By way of example, contacts (17) and contact receptacles (18) can connect the touch sensor (3) and the control unit (5) to one another and suitable plugs and lines (19) can connect the control unit (5) and the computer (6) to one another. Other connections are possible. Although further connections (e.g. to the imaging element (4)) are not shown, they are known to a person skilled in the art.

### EXAMPLE 2

FIG. 1 schematically shows the setup of a transparent, planar covering element (2) according to the invention, in this case in the exemplary form of an acrylic glass pane or (an optionally composite) glass pane, of which a section with an associated detection system (1) is shown, wherein the covering element (2) may be tinted in color, e.g. printed black, or illuminated by means of LEDs (e.g. white and/or blue) (not shown) e.g. outside of the region of the detection system (1) according to the invention (for example from behind, i.e. wall-side, i.e. above the covering element in the figure) for design reasons or for improving the functionality. In the embodiment shown here, the associated detection system (1) is provided fastened to the covering element (2) (e.g. glass wall) from behind by means of suitable fastening means, in this case e.g. nuts (14) fastened (e.g. adhesively bonded) to the covering element (2) and associated bolts (15), if need be via spacer rings (16), which may make separate provisions for preventing optical interference, such as Newton rings, necessary, in this case in the form of a thin layer with a transparent contact liquid (14) which, for this purpose, can have, in particular, a refractive index approximately equal to the covering element and the facing surface of the detection system (1). The detection system (1), used according to the invention, in this case embodied as touch panel, contains a touch sensor (3), furthermore an imaging element (4) (embodied here as screen), a control unit (5) and a computer (6) with software drivers. As shown in FIG. 1, the computer (6) and the control unit (5) can be brought into direct contact (as shown here via screws, but also via different fastening options), via a screen mount (7), for example a display sheet, with the imaging element (4) and can be connected thereto and to the covering element (2) by means of suitable fastening methods (such as the adhesively bonded bolts and associated nuts shown here), wherein a dust seal (8) can also be provided. A cover (9) (shown in folded-up top view) be provided with different connectors, such as one or more selected from an Ethernet connector (10), an RS-422/RS-232/CAN connector (11), a 24 volt connector (12) and a USB connector (13), or a LON or BACnet, for example to enable the actuation of external appliances or devices (not shown here) by means of suitable connections, wherein it is also or alternatively possible for radio links to be provided. Here, the detection system (1) together with the remaining aforementioned components is provided in a recess in a wall (not shown here) and can for example be provided to be accessible from the rear side thereof or via channels in the interior thereof.

1. An operating theater comprising an at least partly transparent, planar covering element (2), equipped with a detection system (1) that detects a presence or characterization of an object or a substance, the covering element (2) is attached in front of, or on, a wall substrate of a wall of a building, substantially over a whole area thereof, and the detection system (1) operates according to a “projected capacitive touchscreen” principle and is provided adjacent to the transparent, planar covering element (2), situated on a rear side as seen from the observer, and in front of, or in, the wall substrate with the covering element (2).

2. The operating theater with the covering element (2) and the detection system (1), as claimed in claim 1, wherein the detection system is an operating element which can simultaneously work as an input and output device, in which a program flow of the device is controlled directly or via control elements by touching parts of an image.

3. The operating theater with the covering element (2) and the detection system (1), as claimed in claim 1, wherein the detection system comprises as components at least one touch sensor (3), which produces signals due to proximity of, or contact with, objects or substances, at least one control unit (5), which translates the signals received from the touch sensor (3) for at least one computer (6), and at least one software driver, which enables an interpretation, processing and use of data supplied by the control unit.

4. The operating theater with the covering element (2) and the detection system (1) as claimed in claim 3, wherein the detection system (2) contains at least one imaging element (4) as a further component.

5. The operating theater with the covering element (2) and the detection system (1) as claimed in claim 1, further comprising one or more further constituents selected from: actuated or actuatable appliances or devices, A/D converters, multiplexers, filters, or suitable algorithms for application and use.

6. The operating theater with the covering element (2) with the detection system (1) as claimed in claim 1, wherein the covering element (2) is at least partly transmissive to electromagnetic waves.

7. The operating theater with a covering element (2) as claimed in claim 1, wherein the covering element (2) comprises a coated material coated by a surface-hardening, anti-glare, electrochromic, colored (e.g. by printing) or other material or coating system or, consists of an uncoated, transparent material such as plastic or, in particular, glass.

8. The operating theater with the covering element (2) as claimed in claim 1, wherein a thickness of the covering element lies in the range between 0.1 and 30 mm.

9. The operating theater with the covering element (2) as claimed in claim 1, wherein the covering element has an area between 2 and 500 square meters.

10. The operating theater with the covering element (2) as claimed in claim 1, wherein the covering element is attached in front of, or on, the wall substrate of the wall of a hospital building, substantially over the whole area thereof.

11. The operating theater with the covering element (2) as claimed in claim 1, comprising a wherein the detection system (2) operates according to the “self capacitance” or “mutual capacitance” principle.

12. The operating theater with a covering element (2) as claimed in claim 1, wherein the detection system (1) is arranged behind only part of the area of the covering element (2).

13. The operating theater as claimed in claim 1, wherein the whole wall area is covered by the transparent covering element (2) or the transparent covering element (2) is embodied in such a way that it is connected to adjoining covering elements (2) on wall regions, or else on ceiling, wall and ceiling regions or floor regions, of a room in a flush manner.

14. The method of using a detection system (1) operating according to a “projected capacitive touchscreen” principle, comprising placing an operating element with the detection system, in front of or in a wall substrate and behind a transparent covering element (2) for keeping an unobjectionable hygienic state of surfaces, and carrying out control functions for medical appliances and devices, said functions need not be directly accessible from the operating site, including functions of the room selected from at least one of illumination regulation, ventilation regulation, or temperature regulation, which occur during surgery or just before or thereafter.

15. (canceled)

16. The method of using a detection system (1) operating according to a “projected capacitive touchscreen” principle, comprising placing an operating element with the detection system in front of or in a wall substrate and behind a transparent covering element (2), and carrying out control functions for a room selected from at least one of controlling heating, tv appliances, an oven, music equipment, home, or cinema equipment.
